(19) United States
(12) Patent Application Publication
(10) Pub. No.: US 2014/0279014 A1
(43) Pub. Date: Sep. 18, 2014

(54) PUSH NOTIFICATIONS FOR LOCATION-BASED CONTENT DELIVERY

(71) Applicant: COX COMMUNICATIONS, INC., Atlanta, GA (US)

(72) Inventors: Pujan Roka, Atlanta, GA (US); Radhakrishnan Gopinath, Atlanta, GA (US); Andrew Goldberg, Atlanta, GA (US); Mike Pons, Atlanta, GA (US)

(73) Assignee: COX COMMUNICATIONS, INC., Atlanta, GA (US)

(21) Appl. No.: 14/211,059

(22) Filed: Mar. 14, 2014

Related U.S. Application Data
(60) Provisional application No. 61/800,137, filed on Mar. 15, 2013.

(51) Int. Cl. G06Q 30/02

(52) U.S. Cl. CPC G06Q 30/0261; G06Q 30/0267
USPC 705/14.58

(57) ABSTRACT

Certain embodiments herein may be directed to push notifications for location-based content delivery. Many merchants use coupon printers to print post-purchase coupons. The systems and methods described herein are directed to generating incentives, such as coupons or loyalty points which may be based at least in part on purchases, the current location of the user in proximity to items or stores, and associating the incentives to a user profile associated with the user. The incentives may then later be retrieved by a point of sale (POS) system of a merchant and then applied to any future purchase transactions the customer may desire.

### RELATED APPLICATIONS

This application claims priority to U.S. Provisional Patent Application No. 61/800,137, entitled “Push Notifications for Location-Based Content Delivery,” filed on Mar. 15, 2013, the contents of which are incorporated by reference herein in their entirety.

### TECHNICAL FIELD

Embodiments of this disclosure relate generally to content delivery, and more particularly, to push notification for location-based content delivery to mobile devices.

### BACKGROUND

Merchants may attempt to reach customers through email and website advertisements and provide coupons to increase their customer base. However, shoppers often do not remember the advertisements while they are out shopping or may have forgotten to bring the advertisement or coupon to the retail location. Merchants often attempted to reach customers during the shopping experience through public announcement systems, signage or other means for attracting the shoppers' attention, such as flashing lights or product demonstrations at certain locations within a store where discounts are offered in the retail store.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1A depicts an illustrative system architecture for location-based content delivery, in accordance with one or more embodiments of the disclosure.

FIG. 1B depicts a more detailed system architecture for location-based content delivery, in accordance with one or more embodiments of the disclosure.

FIG. 1C depicts a more detailed system architecture for location-based content delivery, in accordance with one or more embodiments of the disclosure.

FIG. 2A depicts a block diagram of a user device configuration for location-based content delivery, in accordance with one or more embodiments of the disclosure.

FIG. 2B depicts a block diagram of a location aware content server configuration for location-based content delivery, in accordance with one or more embodiments of the disclosure.

FIG. 3 depicts an illustration of a user device displaying a sample output for push notification for location-based content delivery, in accordance with one or more embodiments of the disclosure.

FIG. 4 depicts a flow diagram of a method for generating and associating incentives in a location-based content delivery system, in accordance with one or more embodiments of the disclosure.

FIG. 5A depicts a flow diagram of a method for location-based content delivery, in accordance with one or more embodiments of the disclosure.

FIG. 5B depicts a flow diagram of a method for location-based content delivery, in accordance with one or more embodiments of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Certain embodiments herein may be directed to push notifications for location-based content delivery. Many merchants use coupon printers to print post-purchase coupons. The systems and methods described herein are directed to generating incentives, such as coupons, discounts, advertisements or loyalty points which may be based at least in part on purchases, the current location of the user in proximity to items or stores, and associating the incentives to a user profile associated with the user. The incentives may then later be retrieved by a point of sale (POS) system of a merchant and then applied to any future purchase transactions the customer may desire.

While various embodiments and features of the present disclosure are described in the context of a single merchant or retail site, it will be appreciated that the solutions described herein may equally be applied to malls, shopping districts, entertainment venues, festivals, sporting arenas, etc., where a plurality of merchant are co-located.

FIG. 1A depicts an illustrative system architecture for location-based content delivery, in accordance with one or more embodiments of the disclosure. A location-based content delivery system 100 may include an indoor positioning system (IPS) that may define an IPS local coverage area 102. The IPS local coverage area 102 may include indoor and/or outdoor locations. Examples of IPS local coverage areas 102 where the IPS may be used include, but are not limited to, hospitals, hotels, sports arenas, airport terminals, outdoor festivals, and shopping malls. Each IPS location may be a physical location in the IPS local coverage area 102. Examples of IPS locations may include, but are not limited to, businesses (e.g., stores, concession stands, and retail kiosks), facilities (e.g., restrooms, elevators, security offices, clinics, and information kiosks), and defined areas (e.g., seating sections, food courts, entrances/exits, gates, lobbies, and casinos). Although described in the context of an indoors system, the IPS may have utility in outdoor and/or mixed indoor/outdoor local coverage areas. For example, IPS may be useful in locations where the lack of an adequate number of nearby cellular towers, and/or where structures may block or limit GPS signals and/or cellular signals to limit the availability or reduce the accuracy of position information provided by GPS and/or other location services. In various embodiments, the IPS may include outdoor IPS beacons 104 to create geo-fencing applications.

The IPS local coverage area 102 may be covered by a number of IPS beacons 104a-104n (collectively referred to as 104) which may be located within or proximate to the IPS local coverage area 102. The IPS beacons 104 may be linked to (and may be supplied by) an IPS provider. Each IPS beacon 104 may be configured with a unique identifier and, optionally, additional information about the IPS beacon 104. Generally, the IPS may include IPS beacons 104 to provide IPS signal coverage of the entire IPS local coverage area 102. The IPS beacons 104 may permit the IPS to determine the position of a user device 106 within the IPS local coverage area 102. The precision of the position determined by the IPS may be a function of the number of IPS beacons 104 used.

One purpose of the IPS beacons 104 may be to transmit an IPS identifier (IPS ID) that is used in determining the location of the user device 106. The IPS beacons 104 may be radio frequency transmitters/transceivers operating on frequencies commonly receivable by a mobile computing device. Examples of suitable frequency ranges include, but are not limited to, the frequency ranges of radio frequency identification (RFID), Wi-Fi, and Bluetooth communications. Further, the IPS beacons 104 may transmit signals that are receivable using one or more application program interfaces (APIs) of a mobile computing device 106. Examples of suitable IPS beacons 104 may include, but are not limited to, wireless access points, RFID transponders, and Wi-Fi or Bluetooth-enabled devices such as a laptop or other computing device.

The IPS ID may uniquely identify the IPS beacon 104 within the IPS local coverage area 102. Examples of suitable unique identifiers may include, but are not limited to, Media Access Control (MAC) addresses, service set identifier (SSID), custom identifiers added to the configuration of the local radio frequency transmitter, and various combinations thereof. In various embodiments, the IPS beacon 104 configuration may include additional IPS information that may be transmitted by the IPS beacon 104. Examples of the additional IPS information may include, but are not limited to, an IPS local coverage area identifier, an IPS subscriber identifier, and other information about the IPS local coverage area 102, the IPS subscriber, and/or the IPS beacon 104. In some embodiments, the additional configuration information may be transmitted with the IPS ID. In other embodiments, the additional configuration information may be transmitted in response to a request from the user device 106.

In various embodiments, the IPS may offer value added services to IPS subscribers. IPS subscribers may be businesses at the IPS local coverage area 102 which may contract with the IPS provider for the ability to interact with user devices 106 subscribed to the IPS. In various embodiments, an IPS beacon 104 may be associated with a corresponding IPS subscriber. In other embodiments, the IPS subscriber transmitter may be a new IPS beacon 104 dedicated to the IPS subscriber and added to the IPS. In various embodiments, the IPS subscriber transmitter may be located within or proximate to the physical location of the corresponding IPS subscriber.

An IPS client on a user device 106 may communicate with a location aware content server 108 accessible over a network 110 (e.g., a local area network or a wide area network). The location aware content server 108 may perform functions to facilitate location-based content delivery, such as determining a relative location of a user device 106 in an IPS local coverage area 102. The location aware content server 108 may use a positional reference system (e.g., a coordinate system or a grid) that corresponds to the IPS local coverage area 102. The physical position of the IPS beacon 104 may be associated with a location in the positional reference system and linked using an IPS ID of the IPS beacon 104. In various embodiments, a graphical representation of the IPS local coverage area 102 (e.g., a map) may be associated with and linked to the positional reference system. Once the IPS beacon 104 is linked to the positional reference system, the IPS may be able to provide position information by determining the relative position of the IPS client to the IPS beacon 104.

Once a map is linked to the positional reference system, the IPS may be able to provide a graphical representation of the position of the IPS client relative to the IPS beacon 104. In various embodiments, paths representing common areas (e.g., hallways, corridors, stairways, or elevators) that connect IPS locations may be associated with the positional reference system. Once paths are linked to the positional reference system, the IPS may be able to provide route information to inform the user of the user device 106 executing the IPS client how to reach a selected IPS location from the current position of the IPS client. In various embodiments, the IPS also provides navigation services that update the position of the IPS client along the route and optionally provides “turn-by-turn” directions as the IPS client reaches a path junction (i.e., a point where two or more paths meet). In some embodiments, the location-based content delivery system may send notification of a sale of a particular item or a sale in a particular store. The notification may include directions presented to the user by the IPS client. In some embodiments, the notification may indicate that a sale or event may be limited in supply or only within a limited time frame. For example, a store may offer a 20% discount on children's shoes for the next 30 minutes or $10 off the next 20 pairs of shoes sold.

FIG. 1B depicts a more detailed system architecture for location-based content delivery, in accordance with one or more embodiments of the disclosure. In brief overview, one or more user devices 106a-106n (collectively 106) may communicate with one or more IPS beacons 104a, 104b, 104c (collectively 104). The one or more IPS beacons 104 may communicate with an IPS appliance 114. The IPS appliance 114 may communicate with a location aware content server 108 over one or more networks 110. One or more user devices 106 may also communicate with a cloud notification push server 112 over one or more networks 110.

For the purposes of this discussion, the user device 106 may include, but is not limited to, a tablet computer, a notebook computer, a netbook computer, a personal digital assistant (PDA), a cellular telephone, a smart phone, a digital reader, gaming device, or any other suitable electronic device with communicative, processing, and storage capabilities. In one aspect, the user device 106 may be a portable or mobile electronic device. The user devices 106 may communicate with one or more IPS beacons 104 over wireless communication protocols, such as Wi-Fi or Bluetooth. The user devices 106 may transmit data associated with the user device 106 and/or associated with the user of the user device 106.

The IPS beacon 104 may receive information from one or more user devices 106. The IPS beacon 104 may communicate with the IPS appliance 114. In some embodiments, the IPS beacon 104 may transmit data received from one or more user devices 106. The IPS beacon 104 may also transmit data associated with itself, such as an IPS beacon ID. In some embodiments, the IPS appliance 114 may determine the location of a user device 106 based upon, at least in part, data received from one or more beacons 104. In other embodiments, the IPS beacon 104 may communicate with one or more location aware content servers 108. The location aware content server 108 may determine the location of a user device 106 based upon, at least in part, the data received from one or more beacons 104. In some embodiments, the location aware content server 108 may determine the location of a user device 106 based upon, at least in part, the data received from one or more IPS appliances 114. The data received from the one or more IPS appliances 114 may include data associated with one or more user devices 106 and/or data associated with one or more beacons 104.

The IPS appliance 114 may communicate with one or more location aware content servers 108. The location aware content server 108 may determine a location of one or more user devices 106, may identify one or more users associated with the user device 106, may determine a location of the user device 106, and may determine content associated with the determined location of the user device 106. In some embodiments, the content may include, but are not limited to, advertisements, coupons, messages, games, information, notifications, maps, directions, or other data that may be included in targeted messages to users. In some embodiments, the location aware content server 108 may communicate with a cloud notification push server 112. The location aware content server 108 may transmit data identifying the content and data associated with the user device 106. The cloud notification push server 112 may generate messages or notifications associated with the identified content and may transmit the messages or notifications to the user device 106 over one or more networks 110. The functionality of 108, 112, and 114 may be centralized at a single computing device or server, or distributed among multiple devices as desired.

FIG. 1C depicts a more detailed system architecture for push notifications for location-based content delivery, in accordance with one or more embodiments of the disclosure. FIGS. 1B and 1C are similar in many respects, thus only the differences are discussed in further detail. In brief overview, one or more user devices 106 may communicate with one or more IPS beacons 104. Additionally, one or more user devices 106 may be in communication with POS equipment 170 of a merchant. The one or more IPS beacons 104 may communicate with an IPS appliance 114. The IPS appliance 114 may communicate with a location aware content server 108 over one or more networks 110. One or more user devices 106 may communicate with a cloud notification push server 112 over one or more networks 110. The cloud notification push server 112 (also known as a “push server”) may communicate with a notification engine 155. The notification engine 155 may communicate with one or more storage devices 160 for storing the content, which may include but are not limited to advertisements, coupons, messages, games, or other content. The location aware content server 108 may communicate with an analytics engine 165.

The POS equipment 170 may comprise any type of POS equipment that may be communicate over one or more networks 110 with the various servers and engines in the system 150. The POS equipment 170 may include at least a user interface or display that the user may interact with to identify themselves or authorize association of incentives with their user device 106 and/or user profile. Additionally, the POS equipment 170 may include one or more network interfaces to facilitate communication with the various servers and engines in the system 150. In some embodiments, the POS equipment 170 may communicate with one or more IPS beacons 104 to obtain information regarding the location of customers or the presence of user devices 106 in the store.

The location aware content server 108 may receive information associated with the one or more user devices 106 and information associated with one or more IPS beacons 104 from the IPS appliance 114. The location aware content server 108 may, in some embodiments, determine a location of a user device 106 based upon information received from the IPS appliance 114. In some embodiments, the location aware content server 108 may use information associated with the IPS local coverage area 102, such as a map of the area or measurements of the IPS local coverage area 102, location of retail stores, or other identifying information about the IPS local coverage area 102. The location aware content server 108 may transmit information received from the IPS appliance 114 and/or information generated by the location aware content server 108 to an analytics engine 165. The analytics engine 165 may process or analyze the received data. In some embodiments, the analytics engine 165 may create reports, such as heat maps, dwell times associated with a particular user device 106, density maps, and other types of information based upon the information received from the location aware content server 108. The analytics engine 165 may transmit the processed data or reports to the location aware content server 108. In some embodiments, the location aware content server 108 may provide the processed data or the reports to a merchant or IPS subscribers. The processed data or reports may be provided to a merchant or an IPS subscriber through a web portal, emails, texts, or other types of communication.

The location aware content server 108 may communicate with the notification engine 155. The notification engine 155 may obtain relevant content (e.g., an advertisement or coupon) based upon the location data and/or processed data or reports received from the location aware content server 108. In some embodiments, the notification engine 155 may retrieve or obtain content from a storage device 160 associated with the notification engine 155. The notification engine 155 may then generate a notification based upon the location of a user device 106 and a relevant content and transmit the notification to the cloud notification push server 112. The cloud notification push server 112 may transmit the notification to the user device 106. The notification may be presented to a user of the user device 106. For example, a user may respond to a notification message containing a link to a coupon by clicking on a hyperlink in the notification to obtain the coupon for redemption. As will be appreciated by those in the art, the functionality of the devices, appliances and servers discussed herein (e.g., items 108, 112, 114, 155, 160, 165) may be combined or distributed among one or more devices, appliances and servers in a manner other than described herein, such as with a centralized server, as may be desired.

FIG. 2A depicts an illustrative diagram of a user device configuration for location-based content delivery, in accordance with one or more embodiments of the disclosure. The user device configuration 200 may include one or more user device(s) 106 that may be used by one or more users.

Each of the user device(s) 106 may include at least one memory 204 and one or more processing units (or processor(s)) 202. The processor(s) 202 may be implemented as appropriate in hardware, software, firmware, or combinations thereof. Software or firmware implementations of the processor(s) 202 may include computer-executable or machine-executable instructions written in any suitable programming language to perform the desired functions. Similarly, hardware implementations of the processor(s) 202 may be configured to execute computer-executable or machine-executable instructions to perform the various functions described.

The memory 204 may store program instructions that are loadable and executable on the processor(s) 202, as well as data generated during the execution of these programs. Depending on the configuration and type of user device 106, the memory 204 may be volatile (such as random access memory (RAM)) and/or non-volatile (such as read-only memory (ROM), flash memory, etc.). The user device 106 may also include additional removable storage and/or non-removable storage (not shown) including, but not limited to, magnetic storage, optical disks, and/or tape storage. The disk drives and their associated computer-readable media may provide non-volatile storage of computer-readable instructions, data structures, program modules, and other data. In some implementations, the memory 204 may include multiple different types of memory, such as static random access memory (SRAM), dynamic random access memory (DRAM), and/or ROM.

The memory 204 and/or the additional storage (not shown), removable and/or non-removable, are all examples of computer-readable storage media. For example, computer-readable storage media may include volatile and/or non-volatile, removable and/or non-removable media implemented according to any method or technology for storage of information such as computer-readable instructions, data structures, program modules, and/or other data. Further, the user device(s) 106 may each further include additional components that are not depicted such as, for example, communications connection(s), input/output (I/O) devices, and so forth.

A web browser 205 may be loaded into the memory 204. The web browser may be invoked by one or more user applications 206 or may be used to display or otherwise present content to a user of a user device 106.

One or more user applications 206 may be loaded into the memory 204. The user application 206 may be any application capable of facilitating the display of, or otherwise presenting content, the user of the user device 106 based upon the location of the user device 106. For example, the user application 206 may present content such as advertisements or coupons to users through user devices 106. The user application 206 may include, but is not limited to, a web-based browser application. For example, the location-based content delivery may be provided to the user through the web browser 205. In some embodiments, the location-based content delivery may be provided to the user through a dedicated software application, such as an IPS client 207. In some embodiments, a user device 106 may include a data store for storing information associated with location-based content delivery. The dedicated software application may be capable of creating, storing and using credentials to authenticate the user device 106 with the location aware content server 108. The dedicated software application may be capable of processing data and determining the location of the user device 106 in the context of an IPS local area coverage 102.

The IPS client 207 may communicate with the location aware content server 108, IPS beacons 104, IPS appliance 114, push server 112, notification engine 155, analytics engine 165, and other components as required to achieve the functionality described herein and that which is inherent to in the present description. In some embodiments, the IPS client 207 may obtain indoor positioning information and any available value added services. For example, an IPS client 207 may include a map application 208 which may display the location of the user device 106 relative to an IPS local coverage area 102. In some embodiments, the map application 208 may determine a location of the user device 102 in an IPS. Communications between the user device 106 and the location aware content server 108 may be in the form of requests and responses; however, in some embodiments, communications may be in the form of broadcasts. Any of the requests or responses described herein may be made up of one or more messages, as necessary or desired. Further, multiple requests or responses may be combined into a single message when desired or practicable. In some embodiments, IPS client 207 may include user account data 210. User account data 210 may include a username and password associated with the user device 106 and the location aware content server 108. In some embodiments, the user account data 210 may include histories of previous interactions with the location aware content server 108, prior content that was presented to the user, previous location information, and other information associated with the user device 106.

In various embodiments, the IPS client 207 may be invoked by a user of the user device 106. In other embodiments, an IPS-enabled map application 208 may be invoked on the user device 106 when entering an indoor location with a specific IPS ID. In some embodiments, a GPS-enabled map application may invoke the indoor positioning system based on the current position of the user device 106. For example, the GPS-enabled map application may invoke the indoor positioning system when the user device 106 is located at a particular latitude and longitude. The IPS-enabled map application 208 may query the location aware content server 108 based upon a received IPS ID associated with an IPS beacon 104 to locate the corresponding indoor map, and may display the location of the IPS beacon 104 associated with the IPS ID on the map.

Now referring to FIG. 2B, an illustrative diagram of a location aware content server 108 configuration for location-based content delivery, in accordance with one or more embodiments of the disclosure, is depicted. The location aware content server 108 may include at least one memory 228 and one or more processing units (or processor(s)) 230. The processor(s) 230 may be implemented as appropriate in hardware, software, firmware, or combinations thereof. Software or firmware implementations of the processor(s) 230 may include computer-executable or machine-executable instructions written in any suitable programming language to perform the various functions described. Similarly, hardware implementations of the processor(s) 230 may be configured to execute computer-executable or machine-executable instructions to perform the various functions described.

The memory 228 may store program instructions that are loadable and executable on the processor(s) 230, as well as data generated during the execution of these programs. Depending on the configuration, the memory 228 may be volatile, such as random access memory (RAM), and/or non-volatile, such as read-only memory (ROM), flash memory, etc.

Turning now to the contents of the memory 228, the memory 228 may include any number of suitable memory devices, such as caches, read-only memory devices, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, magnetic storage devices, removable storage devices (e.g., memory cards, etc.), and/or non-removable storage devices. As desired, the memory 228 may include internal memory devices and/or external memory devices in communication with systems 100, 125, 150.

The memory 228 may store data, executable instructions, and/or various program modules utilized by the processor 230. Examples of data that may be stored by the memory 228 include data files and any number of suitable program modules and/or applications that may be executed by the processor 230, such as, but not limited to, an operating system (O/S) 240, a notification module 212, a transaction module 214, a mediation module 216, a location awareness module 218, a location analytics module 220, a notification engine module 222, an advertisements module 224, and/or user profile module 226. Each of these modules may be implemented as individual modules or, alternatively, one or more of the modules may perform all or at least some of the functionality associated with the other modules. In certain embodiments, these modules may be stored as firmware in a read-only memory, thereby making it more difficult for the functions described herein to be tampered with or disabled.

The I/O devices 232 may include, but are not limited to, a keyboard, a mouse, a pen, a voice input device, a touch input device, a display, a camera or imaging device, speakers, or a printer.

The storage 234 may include removable and/or non-removable storage including, but not limited to, magnetic storage, optical disks, and/or tape storage. The disk drives and their associated computer-readable media may provide non-volatile storage of computer-readable instructions, data structures, program modules, and other data for the computing devices.

The memory 228 and the storage 234, both removable and non-removable, are all examples of computer-readable storage media. For example, computer-readable storage media may include volatile and non-volatile, removable and non-removable media implemented in any method or technology for storage of information such as computer-readable instructions, data structures, program modules, or other data.

The one or more communication connections 236 may allow the location aware content server 108 to communicate with other devices, such as the cloud notification push server 112 or one or more user devices 106, databases, and various other devices that may exist on the one or more networks 110. The communication connections 236 may include various communication interfaces or components that may enable the location aware content server 108 to communicate with other devices, such as one or more user devices 106. Such interfaces or components may include Short Message Service (SMS) text messaging, Internet web pages, or other interfaces that may allow communication from the location aware content server 108 using Bluetooth®, a digital radio network, a cellular network (e.g., third generation and/or fourth generation), a Wi-Fi network, a satellite network, etc.

One or more data stores (not pictured) may store lists, arrays, databases, flat files, etc. In some implementations, the data stores may be stored in memory external to the location aware content server 108 but may be accessible via the one or more networks 110, such as with a cloud storage service. The data stores may store information that may be associated with location-based content delivery as described herein. Such information may include, but is not limited to, customer profiles, user device 106 profiles, shopping history, stores visited, transaction histories, and the like.

In addition to or alternative to the memory 228, other embodiments may include one or more suitable computer-readable media that may be provided for storing computer-executable instructions such as those stored in the memory 228. One or more processing devices, such as the processor(s) 230, may execute such computer-executable instructions to facilitate the location-based content delivery, as described above in association with the modules in the memory 228. As used herein, the term “computer-readable medium” may describe any form of suitable memory or memory device for retaining information in any form, including various kinds of storage devices (e.g., magnetic, optical, static, etc.). Indeed, various embodiments of the disclosure may be implemented in a wide variety of suitable forms.

The operating system 240 may include a suitable module or application that facilitates general operation of the location aware content server 108, as well as the execution of other program modules illustrated in the memory 228.

The integration layer 238 may include the application programming interface (API) 240, the notification module 212, the transaction module 214, and the mediation module 216.

The API 240 may be used as an interface by one or more modules to communicate with each other and to create the user-facing experience.

The notification module 212 may perform a number of functions to trigger notification to the user device 106 based on the notification content (e.g., advertisements) supplied by the notification engine 222. The notification module 212 may generate a notification which may include content identified by the notification engine 222 and transmit the notification. In some embodiments, the notification module 212 may transmit the notification to the user device 106. In some embodiments, the notification module 212 may transmit the notification to the push server 112.

The transaction module 214 may perform a number of functions to manage the user interface and logic for presenting content and tracking user responses and/or interactions with said content, such as ad impressions, click-throughs, redemptions, routes followed, etc. For example, the transaction module 214 may pass transaction data (e.g., advertisement impressions and click-throughs) to the mediation module 216. The transaction module 214 may track the number of coupons and transmittal of coupons to user devices 106. In some embodiments, the transaction module 214 may process transaction data, such as advertisement impressions and click-throughs, as well as whether a user device 106 accessed a hyperlink included in a notification to the user device 106. The transaction module 214 may track the transaction of a coupon based on transaction information received from the merchant or IPS subscriber received. In some embodiments, the transaction module 214 may manage the user interface for redeeming content. For example, the hyperlink transmitted to the user device 106 in the notification may direct the user device to a website or page that contains the content identified by the notification engine 222. The transaction module 214 may generate the page associated with the hyperlink based upon the content identified by the notification engine 222. In some embodiments, the transaction module 214 may generate or render the page based upon, at least in part, information associated with the user device 106. For example, the transaction module 214 may determine that the user device 106 is a smartphone and render a page with a resolution for a smartphone. In some embodiments, the page may include elements permitting the user to select how to redeem or select options associated with the content. For example, the page may contain a button the user must select in order to generate a code to be presented to the retailer to be redeemed. The mediation module 216 may perform a number of functions to facilitate billing transactions and revenue management based upon, at least in part, the content (e.g., advertisements and coupons). For example, the mediation module 216 may receive transaction data (e.g., usage data) from the transaction module 214. In some embodiments, the mediation module 216 may receive processed transaction information from the transaction module 214. The mediation module 216 may obtain information associated with a merchant or IPS subscriber. For example, a merchant may specify a particular budget for an advertising campaign and the frequency of the notifications to user devices 106 as well as rates associated with each of the messages. The mediation module 216 may determine the cost associated with messages transmitted to user devices 106, calculate the budget associated with a merchant or IPS subscriber, or other billing or revenue management functions based upon, at least in part, transaction information received from the transaction module 214 and/or information obtained associated with the merchant or IPS subscriber.

The location awareness module 218 may perform a number of functions to facilitate identification of locations of one or more registered user devices 106. For example, the location awareness module 218 may receive information from one or more user devices 106, one or more IPS beacons 104, one or more IPS appliances 114, IPS local coverage area 102 information, map data associated with the local coverage area 102, and/or other information associated with IPS and the user device 106. In some embodiments, the location awareness module 218 may also receive GPS information associated with the user device 106. The location awareness module 218 may determine the location of one or more registered user devices 106 based upon, at least in part, the received information. The location awareness module 218 may transmit the location of the one or more registered user devices 106 to the respective user devices. In some embodiments, the location data may be collected and/or aggregated and presented to the merchant or IPS subscriber. In some embodiments, the location awareness module 218 may transmit the location of the one or more registered user devices 106 to the analytics engine for processing. In some embodiments, the location awareness module 218 may identify a map associated with the IPS local coverage area 102 and generate an indication of the location of a registered user device 106 to be transmitted to the user device 106. In some embodiments, the maps may be stored locally on the user device 106 and the location awareness module 218 may send a map identifier and instructions to indicate the location of the user device 106 relative to the identified map. In some embodiments, the location awareness module 218 may annotate the map or otherwise generate data so that the user device 106 may annotate a map with different types of information, such as time, traffic, and other information. The location analytics module 220 may perform a number of functions to facilitate processing of location information associated user devices 106 and an IPS, and may also facilitate the creation of analytical reports such as heat maps, dwell time, or density which may be based upon, at least in part, data received from one or more user devices 106, one or more IPS beacons 104, one or more IPS appliances 114, data associated with an IPS local coverage 102, and other information that may be associated with an IPS. The location analytics module 220 may receive information from multiple sources, such as any device in the location-based content delivery system 100 and aggregate the received information. The location analytics module 220 may process the received information to generate reports or statistics associated with content delivery based upon an IPS. In some embodiments, the location analytics module 220 may store data associated with one or more user devices 106, IPS beacons 104, IPS appliance 114, and other devices in the location-based content delivery system. The location analytics module 220 may process the information received from other modules, such as the transaction module 214. Such data may include device traffic data. In some embodiments, the location analytics module 220 may make recommendations or otherwise tailor the information sent to the user devices 106 based upon stored and/or processed information. The notification engine 222 may perform a number of functions to notify one or more user devices 106 of relevant content (e.g., advertisements, coupons) based on location data of the user devices 106. In some embodiments, the notification engine 222 may obtain preference information associated with an identified registered user device 106. In some embodiments, the notification engine 222 may receive the location data associated with the identified registered user device 106. The notification engine 222 may obtain content (e.g., advertisements and/or coupons) based upon, at least in part, the location of the user device 106 and the preferences associated with the user device 106. For example, a person may have specified that they are interested in content associated with pet accessories. The notification engine 222 may receive information identifying a registered user device 106 associate with that person. The notification engine 222 may obtain the preferences of the person (e.g., interest in pet accessories) using the identifying information associated with the registered user device 106. If the person walks by a pet store that sells pet accessories, the notification engine 222 may receive information indicating the location of the person (e.g., near or inside the pet store). The notification engine 222 may identify content based upon, at least in part, the preferences of the person and the current location of the person. Based at least on this information, the notification engine 222 may then identify an advertisement from the pet store for a discount on pet costumes. The notification engine 222 may generate a notification which may include the identified advertisement. The identified advertisement may be retrieved from the content module 224. The location aware content server 108 may transmit the notification to the user device 106. The integration layer 238 may retrieve the notification from this module and transmit it to the notification module 212. The notification module 212 may retrieve preferences associated with the user device 106 from the user profile module 226. Based upon the preferences specified, the notification module 212 may format the notification received from the notification engine 222 for the particular user device 106 and based upon, at least in part, the obtained user preferences. In some embodiments, the notifications may also be formatted using preferences specified by merchants or IPS subscribers for content delivery.

The content module 224 may perform a number of functions to facilitate management of content. For example, the content module 224 may receive content, such as advertisements, coupons, messages, games, videos, or other type of content. In some embodiments, the content module 224 may categorize the received content. For example, content may be categorized by type, such as advertisements, coupons, or messages. In some embodiments, the content may be categorized by other characteristics, for example, retailer type, product type, or service type. In some embodiments, the notification engine 222 may obtain relevant content from the content module 224.

The user profile module 226 may perform a number of functions to generate and maintain information associated with users of the user devices 106, such as opt-in information and notification preferences. In some embodiments, the user profile module 226 may maintain authentication credentials, such as a username and password, token, or license to identify or register the user device 106 to the location-based content delivery system 100. In some embodiments, the user profile module 226 may receive user preference information, such as preferences associated with content, frequency of message deliveries, types of message deliveries, and/or an indication to participate in content delivery. For example, a person may specify they do wish to receive only content associated with menswear. The person may specify specific retail locations or merchants they wish to receive messages, frequency of the messages, message type (e.g., SMS message, email message, voice message) or other type of information associated with the preferences of the user.

In some embodiments, one or more computing devices of the location-based content delivery system 100 may also include an authorization module (not pictured) and/or third party applications (not pictured). An authorization module may perform a number of functions to authorize communication between one or more modules through application programming interfaces (API) 240 to enable content delivery to user devices. User device 106 authentication, verification may be based upon, at least in part, data maintained by the user profile module 226. The third-party applications are applications that may leverage location-based content provided by the platform and generate revenue from advertisement notifications and click-throughs. Although the modules above have been described in conjunction with a location aware content server 108, the modules may reside on any computing device of the location-based content delivery system as described herein.

FIG. 3 depicts an illustration of an IPS client 207 displaying on a user device 106 a sample output for location-based content delivery, in accordance with one or more embodiments of the disclosure. The cloud notification push server 112 may transmit a message to the IPS client 207 of the user device 106. The user device 106 may display a notification 305. The user may then select the notification 305, for example, by clicking in the notification, which may cause the user device 106 to display content 310 such as an advertisement, a coupon or other incentive that may be retrieved from the location aware content server 108. In some embodiments, the IPS client 207 may send a request to the location aware content server 108 responsive to a user selecting a hyperlink to a coupon. Responsive to the request, the location aware content server 108 may transmit a response which may include the requested content (e.g., coupon). In some embodiments, the content may have been received by the user device 106 with the notification and stored in local memory. When the user requests the content, the user device 106 may retrieve the content stored in local memory of the user device 106. The functionality for location-based content delivery system may be distributed among one or more computing devices as desired.

FIG. 4 depicts a flow diagram of a method for push notifications of post purchase incentives. In some embodiments at exchange 405, a customer may complete a purchase transaction via the POS equipment 170. In some embodiments, the customer may provide identifying information, such as an email address that may be associated with the customer in a user profile. In some embodiments, the purchase transaction may be completed using stored payment information. In some embodiments, the POS equipment 170 may query the user profile module 226 to identify any incentives that were previously accumulated and associated with the user profile. In some embodiments, the POS equipment 170 may ask the user if they'd like to apply any available incentives to their current purchase. In some embodiments, the POS equipment may apply any available incentives previously accumulated to the current purchase. In some embodiments, responsive to applying one or more incentives to the current purchase, the POS equipment 170 may communicate with the user profile module 226 to update the status of any incentives that may have been applied to the transaction. For example, the POS equipment 170 may transmit a message to the user profile module 226 indicating that a coupon had been applied. The user profile module 226 may then update the user profile to indicate that the coupon had been utilized.

At exchange 410, the POS equipment 170 may issue an electronic incentive, such as a coupon or loyalty points. In some embodiments, the POS equipment 170 may generate electronic incentives based at least in part on user preferences, user transaction or shopping history, user-specified shopping list, the current purchase, or other data that may be associated with the user device 106 or user profile.

At exchange 415, the POS equipment 170 may detect the user device. In some embodiments, the POS equipment 170 may automatically detect a nearby user device 106 based at least in part wireless sensors of the POS equipment 170 that detect whether the user device 106 is configured to join the network or is configured to communicate with the POS equipment. In some embodiments, the user device 106 may be detected by one or more IPS beacons 104, via a Bluetooth™ connection, via an NFC interface or the like.

At exchange 420, the POS equipment 170 may ask the user or customer to associate the incentive to the user device 106 and/or user profile. In some embodiments, the POS equipment 170 may transmit a message to the user device 106 asking to associate the incentive to the user device 106 and/or user profile. The message may contain a link to allow the user to accept the association of the incentive to the user device 106 and/or user profile. In some embodiments, the POS equipment 170 may display to customer via an interface of the POS equipment 170, a message requesting the user to associate the incentive to the user device 106 and/or user profile. The message displayed on the interface may request the user to select an option, either via a touchscreen display or be selecting a button of the POS equipment 170 either accepting or denying the association.

At exchange 425, the user may confirm and authorize the POS equipment 170 to associate the incentive with the user device 106 and/or user profile. In some embodiments, the user or customer may click on the hyperlink in a receive message or select an option associated with a displayed message to authorize the association of the incentive with the user device 106 and/or user profile.

At exchange 430, the POS equipment 170 may transmit a message to the user profile module 226. The message may be transmitted over one or more networks 110 to the user profile module 226. The user profile module 226 may update incentives associated with the user device 106 and/or user profile to reflect the addition of the incentive in association with the recent purchase.

FIG. 5A depicts a flow diagram of a method for location-based content delivery, in accordance with one or more embodiments of the disclosure.

In some embodiments, at exchange 501, a user device 106 may receive obtain a user application 206 for location-based content delivery. In some embodiments, the IPS client 207 may be part of the user application 206. In some embodiments, the IPS client 207 may be a separate dedicated application that may need to be obtained by the user device 106. A user device 106 may obtain the user application 206 and/or the IPS client 207 in response to receiving a code. For example, a user device 106 may receive a Quick Response (QR) code or a barcode, near field communication (NFC), or receive an audible code. Responsive to receiving the code, the user device 106 may launch a web browser or an application to obtain the user application 206 and/or the IPS client 207.

In some embodiments, a user of the user device 106 may indicate he or she wishes to receive content, such as advertisements, coupons, maps, videos, messages, or other content. A user device 106 may receive certain data from the user such as information to establish a user account or otherwise request content. At exchange 502, the user device 106 may transmit the data to the user profile module 226. The data transmitted to the user profile module 226 may include a user device identifier such as a MAC address, user preferences, and information collected from the user to be authenticated by the location-based content delivery system 100. The data may also include preferences for content, such as an indication of an interest in food, sports, specific stores, etc. In some embodiments, the user profile module 226 may determine if a user profile for the user exists. If a user profile does not exist, at exchange 503, the user profile module may transmit a generated user identifier or confirmation of creation of a profile for the user. At exchange 504, the user device 106 may transmit the newly generated device registration information to one or more IPS beacons 104 in the location-based content delivery system. If a user profile exists, the user profile module 226 may update or otherwise modify the user profile based upon, at least in part, the data received from the user device 106.

In some embodiments, at exchange 506, the user profile module 226 may transmit the data associated with the user device 106 and/or the user to the location awareness module 218. For example, the user profile module 226 may notify the location awareness module 218 of the user device identifier indicating the user device 106 is registered or otherwise known to the location-based content delivery system.

In some embodiments, at exchange 508, the location awareness module 218 may receive 508 data from one or more IPS beacons 104. For example, the IPS beacons 104 may determine, based upon the user device identifier, whether a user device 106 is connected or not connected. IPS beacons 104 may identify registered user devices 106 when they come in proximity to the IPS beacon 104. For example, a shopper may have registered his or her phone, and wireless access has been enabled on the phone. When the shopper walks by a particular store, an IPS beacon 104, which may be located inside or near the store, may identify the registered user device 106 and communicate with the user device. The IPS beacon 104 may obtain identifying information from the user device 106 such as a user device identifier (e.g., MAC address of the user device).

In some embodiments, at exchange 510, the location awareness module 218 may analyze the data received from the IPS beacons 104 to identify a user device identifier. For example, the location awareness module 218 may scan for registered phone MAC addresses.

In some embodiments, at exchange 512, the location awareness module 218 may transmit a notification to the notification engine 222 of registered user device identifiers. For example, the location awareness module 218 may notify the presence of registered user device identifiers (e.g., MAC addresses of user devices 106) to the notification engine 222. In some embodiments, the location awareness module 218 may also transmit to the notification engine 222 IPS beacon 104 identifiers in the proximity of the user device 106.

In some embodiments, at exchange 514, the notification engine 222 may query the user profile module 226 preferences of the identified user devices 106. The user profile module 226 may retrieve and transmit 516 data associated with the identified user device 106. In some embodiments, at exchange 518, the notification engine 222 may query the content module 224 for content associated with the IPS beacon identifier. In some embodiments, the notification engine 222 may query the content module 224 for content based upon multiple factors, which may include but are not limited to user preferences, time of day, day of week, analytic report data, and other types of information. In some embodiments, at exchange 520, the content module 224 may retrieve and transmit content to the notification engine 222.

In some embodiments, at exchange 522, the notification engine 222 may initiate a content notification by transmitting data to the cloud notification push server 112. In some embodiments, at exchange 524, the cloud notification push server 112 may transmit the notification associated with the identified content to the user device 106. In some embodiments, at exchange 526, the user device 106 may acknowledge the notification associated with the content and present the notification to the user. In some embodiments, at exchange 528, the user device 106 may retrieve the content responsive to a user responding to the notification, for example, by clicking hyperlink that may be included in the notification from the cloud notification push server 112.

Now referring to FIG. 5B, a flow diagram of a method for location-based content delivery, in accordance with one or more embodiments of the disclosure, is depicted. FIGS. 5A and 5B are similar in many respects, thus only the differences are discussed in further detail. In some embodiments, at exchange 502, the user device 106 may transmit the data to the user profile module 226. The data transmitted to the user profile module 226 may include a user device identifier such as a MAC address of the user device 106. The data may also include preferences for content, such as an indication of an interest in food, sports, specific stores, etc. In some embodiments, at exchange 555, the user profile module 226 may then register the user device 106 with the cloud notification push server 112. In some embodiments, the user profile module 226 may directly register the user device 106 with the cloud notification push server 112 using identifying information from the user device 106 such as a user device identifier (e.g., MAC address of the user device 106). By registering the user device 106 with the cloud notification push server 112, the user profile module 226 may not need to notify the location awareness module 218 of the user device identifier, as depicted in FIG. 5A. Additionally, the location awareness module 218 may not need to analyze the data received from the IPS beacons 104 to identify a user device identifier (e.g., scan for registered phone MAC addresses) as depicted in FIG. 5A.

In some embodiments, a wireless network provider may provide one or more Internet or web portals where merchants or IPS subscribers may define their targeted messaging and/or content delivery needs. The merchant may log into the portal and define or select multiple parameters. For example, the IPS subscriber may specify a wireless access point in a specific location (e.g., select a particular IPS beacon 104). The IPS subscriber may select an existing access point (e.g., IPS beacon 104) or the IPS subscriber may submit a new access point location. For example, department store ABC Store located inside XYZ Mall may select a common wireless access point that is already publicly available (e.g., may be owned and managed by a third party), or the ABC Store may submit the access point installed inside its retail premise (e.g., privately owned and managed by ABC Store). For the third-party access point, that third party may provide authorization to all or specific parties to utilize their access points. For example, XYZ Mall may choose to allow all merchants to use its public access points, or XYZ Mall may select specific merchants, like ABC Store, to use them.

Another parameter that may be specified by an IPS subscriber is messaging procedures (e.g., types and frequency of notifications transmitted to user devices 106) corresponding to selected access point locations. For example, IPS subscribers may select pre-defined messages (e.g., “Welcome to MY_LOCATION,” where MY_LOCATION is dynamically generated based on the business name defined in the location database) or may define their own customized messages. For example, ABC Store may define or select a message that promotes its own products, or it may select to promote another merchant (e.g., “Get a free AMC pass when you buy Nike Flex.”).

Another parameter that may be specified by IPS subscribers is the frequency of the delivery of messages to the user devices 106. Each delivery of a message to a user device 106 may be considered an impression, similar to ad impressions on the Internet. When the user taps the user device 106 to open the message, then it may be considered as a “click-through.”After the IPS subscriber defines access points and messages corresponding to those access points, the IPS subscriber may select the frequency of delivery of messages. For example, the IPS subscriber may determine to target messages to every registered user device 106 that moves within the range of a given IPS beacon 104, provided the owner of that user device 106 has agreed and opted-in to receive communication on that device. The IPS subscriber may determine to target messages to every registered user device 106 at predetermined times or time intervals. The IPS subscriber may determine to target messages to certain registered user devices 106 in incremental sequence (e.g., every 5th device, every 10th device, or every 100th device). The IPS subscriber may determine to target messages to specific registered user devices 106 that are already known by the merchant or IPS subscriber. The merchant or IPS subscriber may, for example, collect the MAC addresses of user devices 106 during the opt-in process.

In some embodiments, the network provider may also define pricing schemes based on the above frequency of transmitted messages. Some illustrative examples may include: target all devices: $0.01 (impression), $0.02 (click-through); target every 5th device: $0.02 (impression), $0.04 (click-through); or target known devices: $1.00 (impression), $2.00 (click-through).

Another parameter that may be specified by an IPS subscriber may be payment associated with the frequency of transmitted messages. For example, the IPS subscriber may deposit (in prepaid or postpaid arrangement) a budget for messaging campaigns corresponding to the messages and their frequency as described herein. For example, ABC Store may create an advertising campaign with an allocated budget of $1,000 and target known devices (customers they already know). ABC Store would deplete its budget as soon as customer number 1,001 (based on $1 per known device model) walks into its store. The network provider may automatically suspend ABC Store's notification campaign when the budget is depleted.

In some embodiments, the network provider may be responsible for sending messages as defined by the merchants or IPS subscribers, as illustrated above. When a user device 106 is recognized by an IPS beacon 104, the location aware content server 108 may send messages based on the messaging definition specified by the IPS subscriber. The network provider may push messages to only those devices that have opted-in to receive notifications.

The network provider may provide notifications to user applications 206 that are authorized to receive such notifications. For example, a navigation application, such as Google Maps, may subscribe to the wireless network based on notifications enabled by the network provider. The network provider may share revenue with the navigation application for delivering location-based advertisements.

In some embodiments, the location aware content server 108 may receive information from the in-store POS equipment 170 regarding incentives for a user. In some embodiments, the location aware content server 108 may be in communication with a notification engine 155 and storage content 160 to retrieve any existing incentives associated with a user and transmit the data associated with the incentives for a user to the POS equipment 170. In some embodiments, the location aware content server 108 may receive information from the POS equipment 170 regarding newly generated incentives that are associated with the user. The location aware content server 108 may update the information associated with the user profile to reflect the newly accrued incentives for a user.

In some embodiments, the POS equipment 170 may identify a user and their eligibility to receive post purchase incentives at qualifying stores and notify the user the next them they return to the store for subsequent purchase. In some embodiments, the notification to the user may include identifying the present of the user device 106 in a qualifying location (e.g., merchant store or in proximity of a competitor's store). In some embodiments, the user's eligibility to receive a post purchase incentive may be based at least in part on the user's pervious purchase events. In some embodiments, incentives may be generated in the absence of a user device 106 in a qualifying store immediately after its presence has been detected but without any in-store purchase events. In some embodiments, the present of a user device 106 in proximity to a competing store may trigger incentives to be generated for the merchant store and transmitted to the user device 106 and/or associated with the user profile of the user. In some embodiments, the location and time of the presence of the device 106 in a certain location (e.g., store aisle) proximate to a product may generate a push notification to the user device 106 for the product in the merchant store. In some embodiments, incentives may be generated and associated with a user based at least in part on present purchases, past purchases, user profile, location information, or the like.

For example, a user may purchase a product. The POS equipment 170 may generate an incentive, such as an electronic coupon for $1 off on subsequent purchases of the product. Instead of printing the incentive, the POS equipment 170 may alert the user, using the a display of the POS equipment 170, that the incentive may be electronically attached to the mac address of the user device 106 in its close proximity. In some embodiments, the POS equipment 170 may also informs the user that a mobile application may need to be downloaded to redeem the incentive in subsequent store visits. If the user has already downloaded the mobile application, the store's IPS beacons 104 may already have detected the presence of the user device 160, obtain identifying information, such as a MAC address of the device 106 and communicate the information to the POS equipment 170 which may then communicate with one or more servers of the location-based content delivery system 150.

Furthering the example, in subsequent store visits, the system 150 may detect the presence of the user device 106 in the store, query the user profile (updated by the POS equipment 170) to determine whether there is a pending incentive associated with that user device 106. If there is a pending incentive that may be redeemed, the notification engine 155 may retrieve the incentive from the storage content 160, generate a notification that includes the incentive and transmit the notification to the user device 106. In some embodiments, the notification may be transmitted as a push notification.

In some embodiments, the user device may already have the mobile application stored on it that is capable of receiving indoor location-based push notifications, or any mobile application could integrate this capability. The mobile application may be capable of capture user information, such as opt-in information to receive location-based notifications and information that may be used to detect the presence of the user device 106, such as a MAC address of a mobile device. In some embodiments, the user profile may be generated, modified, and stored in content storage 160 of the system 150.

In some embodiments, customers may make a purchase at participating merchants that are enabled by the location-based POS system that is enhanced and integrated to interact with a location aware content server 108. The POS equipment 170 may be configured to associate a relevant incentive, such as an electronic coupon with the purchase event. In some embodiments, the POS equipment 170 may be configured to identify the user associated with the purchase event by identifying the mac address of a user device 106 that is in the close proximity of the POS equipment 170. This may be achieved by a 802.11 sensor attached to the POS equipment 170 that scans for mac addresses in its close vicinity and the target device could be made further accurate by detecting the RSSI value of the Wi-Fi device transmitting its Wi-Fi RF. If there are multiple WiFi devices, then the RSSI value could be used to pick the one that is closest to the POS equipment 170. In some embodiments, the user device 106 with highest RSSI value may be considered as the user device 106. In some embodiments, the POS equipment 170 may communicate with one or more IPS beacons 104 to detect the presence of a user device 106.

In some embodiments, the POS equipment 170 may notify the user (e.g., via a display of the POS equipment 170) that a pending incentive, such as an electronic coupon, has been attached to the user's profile.

In some embodiments, the POS equipment 170 may reach the Wi-Fi RF headers transmitted by a customer's user device 106, identify the type of user device 106 (e.g., Android, iPhone, Windows, etc.), and display the device type name in the POS equipment 170 display screen to the user to confirm. In some embodiments, the user can decline to associate the incentive to their user device 106.

In some embodiments, the POS equipment 170 might detect a user device 106 that may not belong to the customer that is making the actual purchase. In this scenario, the user can decline to associate the coupon to the user device 106.

In some embodiments, when a customer visits the store for subsequent purchases, the IPS beacons 104 or other presence sensing mechanisms may detect the presence of the user device 106. The location aware content server 108 may retrieve incentives associated with the user device 106 from the user profile and send a push notification of that incentive to the user device 106 upon presence detection. This may remind the customer of any incentives that they may redeem for this purchase.

In some embodiments, the systems and methods described herein may be directed to maximizing conversion rates of incentives, maximizing overall conversion value and commissions, or following a particular business rule for redemption of incentives, such as always generating an incentive if a particular condition is true.

In some embodiments, the system and methods described herein may enable generation and delivery of incentives to customers via their user devices 106 based at least in part on prior purchase history, user profile data, current location and proximity to competing merchants or particular items, and other factors.

In some embodiments, if the system 150 detects a user device 106 in proximity to a competing merchant, the system may generate and delivery an incentive, such as a coupon or discount. In some embodiments, the user device 106 may be within a pre-determine threshold from the competing merchant (e.g., within 10 feet of the competing merchant's store). This may enable the merchant to “steal” the customer away from their competitor. In some embodiments, an incentive may be generated it if is detected that a user is proximate to a particular item. In some embodiments, the incentive may be for the particular item. In other embodiments, the incentive may be for a competing item.

In some embodiments, the system 150 may detect that a customer has left the store or a particular location. The system may determine that the customer left the store or location without making a purchase. In some embodiments, this determination may be made by utilizing an RFID sensor associated with the POS equipment 170 and transmitter chips in the shopping bags to determine that a user has left the store without purchasing any items (e.g., because they are leaving the store without any shopping bags with the transmitter chips). Other similar approaches may be utilized to determine that a user has left a store without making a purchase. In some embodiments, the system 150 may then generate an incentive to entice the user to come back and make a purchase. In some embodiments, the incentive may be general to the store, specific to a product category, or specific to a particular product.

In some embodiments, the system 150 may generate incentives and transmit the incentives to user devices 106 prior to purchase, before they've passed a product, or event before they have entered a particular location. For example, if a customer is standing in an aisle of the store, the system 150 may detect that a user device 106 is within a predetermined threshold (e.g., within 2 feet) of a particular product or location in the store and may generate an incentive, such as a coupon when the customer is within the predetermined threshold. This may encourage customers to purchase items that they may not have otherwise have purchased.

In some embodiments, the user device 106 may locally store any incentives generated by the system 150 until they are redeemed or applied to a purchase transaction. This may allow users to track all of their available incentives (e.g., coupons, discounts) which they may need access to while shopping. In some embodiments, the incentives associated with a user device 106 may be accessed via a website, where the customer may log in and view any coupons, discounts, loyalty points or the like. Additionally, the website may permit the user to view any incentives the user may be able to obtain while at the merchant store.

In some embodiments, the system 150 may detect a user device 106 has stayed or lingered in a particular location exceeding a pre-determined period (e.g., more than 3 minutes). This may be indicative of a customer needing assistance. The system 150 may generate a notification to the merchant indicating the customer may need assistance and indicating the proximate location of a consumer. In some embodiments, this may enable the merchant to increase their customer service by sending someone to assist the user.

In some embodiments, the system 150 may detect a user device 106 has stayed or lingered in a particular location exceeding a pre-determined period. The system 150 may generate a notification to provide further assistance to the customer. For example, if the customer is in the cold-medication aisle, and is trying to determine which type of medication to purchase, the system 150 may generate a message containing information about different types of cold medications or a link to a webpage that may display information about different types of cold medication to aid the customer in making a better-educated selection. In some embodiments, the message may include an incentive for a particular brand of medication. In some embodiments, a notification may be generated and transmitted to a pharmacist that may be able to go to the location of the customer to provide in-person assistance.

Certain aspects of the disclosure are described above with reference to block and flow diagrams of systems, methods, apparatus, and/or computer program products according to example embodiments. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, certain embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
determining, by the one or more processors of a computing device, a location of a user device;
generating, by the one or more processors, one or more incentives;
associating, by the one or more processors, the one or more incentives with the user device; and
storing, by the one or more processors, the one or more incentives in association with a user profile associated with the user device

2. The computer-implemented method of claim 1, wherein the location of the user device is determine based at least in part on data received from one or more indoor positioning system (IPS) beacons.

3. The computer-implemented method of claim 1, further comprising:
transmitting, by the one or more processors to the user device, a notification comprising the one or more incentives.

4. The computer-implemented method of claim 1, further comprising:
retrieving, by the one or more processors, a previously associated incentive based at least in part on determining the location of the user device; and
transmitting, by the one or more processors, the previously associated incentive to the user device.

5. The computer-implemented method of claim 1, wherein generating the one or more incentives is based at least in part on at least one of a present purchase transaction, purchase transaction history, the user profile, or the location of the user device.

6. The computer-implemented method of claim 1, wherein the location of the user device is proximate to a competing merchant establishment.

7. The computer-implemented method of claim 1, further comprising:
determining, by the one or more processors, that the user device has stayed in the location exceeding a pre-determined period of time.

8. The computer-implemented method of claim 7, further comprising:
generating, by the one or more processors, a notification to a merchant based at least in part on the determining.

9. The computer-implemented method of claim 7, further comprising:
transmitting, by the one or more processors, a notification to the user device, wherein the notification comprises an incentive associated with an item in a location within a threshold from the location of the user device.

10. The computer-implemented method of claim 7, further comprising:
transmitting, by the one or more processors, a notification to the user device, wherein the notification comprises additional information associated with an item within a predetermined threshold from the location of the user device.

11. A system comprising:
at least one memory storing computer-executable instructions; and
at least one processor, wherein the at least one processor is configured to access the at least one memory and to execute the computer-executable instructions to:
determine a location of a user device;
generate one or more incentives;
associate the one or more incentives with the user device; and
store the one or more incentives in association with a user profile associated with the user device

12. The system of claim 11, wherein the location of the user device is determined based at least in part on location data is received from one or more indoor positioning system (IPS) beacons.

13. The system of claim 11, wherein the at least one processor is further configured to execute the computer-executable instructions to:
transmit, to the user device, a notification comprising the one or more incentives.

14. The system of claim 11, wherein the at least one processor is further configured to execute the computer-executable instructions to:
retrieve a previously associated incentive based at least in part on determining the location of the user device; and
transmit the previously associated incentive to the user device.

15. The system of claim 11, wherein generating the one or more incentives is based at least in part on at least one of a present purchase transaction, purchase transaction history, the user profile, or the location of the user device.

16. The system of claim 11, wherein the location of the user device is proximate to a competing merchant establishment.

17. The system of claim 11, wherein the at least one processor is further configured to execute the computer-executable instructions to:
determine that the user device has stayed in the location exceeding a pre-determined period of time.

18. The system of claim 17, wherein the at least one processor is further configured to execute the computer-executable instructions to:
generate a notification to a merchant based at least in part on the determining.

19. The system of claim 17, wherein the at least one processor is further configured to execute the computer-executable instructions to:
transmit a notification to the user device, wherein the notification comprises an incentive associated with an item in a location within a threshold from the location of the user device.

20. The system of claim 17, wherein the at least one processor is further configured to execute the computer-executable instructions to:
transmit a notification to the user device, wherein the notification comprises additional information associated with an item within a predetermined threshold from the location of the user device.
